(19) United States
(12) Patent Application Publication
(10) Pub. No.: US 2011/0047858 A1
(43) Pub. Date: Mar. 3, 2011

(54) Trap

(76) Inventor: Chang-Cheng Wu, Kaohsiung (TW)

(21) Appl. No.: 12/552,358

(22) Filed: Sep. 2, 2009

(51) Int. Cl. A01M 23/04

(52) U.S. Cl. 43/69; 43/66

(57) ABSTRACT

A trap includes a cage defining a capture space having an opening in an upper end of the cage. A cover is pivotable about a pivot axis between a closing position closing the opening and a revealing position revealing the opening. The cover includes a first end and a second end having a spacing to the pivot axis smaller than the first end of the cover. A counterweight device is mounted to the second end of the cover to bias the cover to the closing position. The cover moves to the revealing position when an animal moves to the first end of the cover, such that the animal falls into the capture space.

### BACKGROUND OF THE INVENTION

The present invention relates to a trap and, more particularly, to a trap for catching animals.

Propagation of animals in an environment without native predators may become a disaster to ecology. As an example, brown tree snakes on Guam have almost caused extinction of most of the birds and lizards on this island and often caused electricity outage. The brown tree snakes slipping into the houses are also a threat to infants. The brown snakes may be carried to other islands by airplanes and ships. Control of the population of animals of certain species is necessary. One of the methods for controlling the population of animals is using traps. However, most conventional traps are either complicated or ineffective in catching animals.

Thus, a need exists for a trap for effectively catching animals while having a simple structure.

### BRIEF SUMMARY OF THE INVENTION

The present invention solves this need and other problems in the field of catching animals by providing, in a preferred form, a trap including a cage defining a capture space having an opening in an upper end of the cage. A cover is pivotable about a pivot axis between a closing position closing the opening and a revealing position revealing the opening. The cover includes a first end and a second end having a spacing to the pivot axis smaller than the first end of the cover. A counterweight device is mounted to the second end of the cover to bias the cover to the closing position. The cover moves to the revealing position when an animal moves to the first end of the cover, such that the animal falls into the capture space.

In the most preferred form, a first magnetic member is mounted on one of the cage and the cover, and a second magnetic member is mounted on the other of the cage and the cover. The first and second magnetic members attract and engage with each other when the cover is in the closing position, maintaining the cage in the closing position.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows an exploded, perspective view of a trap according to the preferred teachings of the present invention.

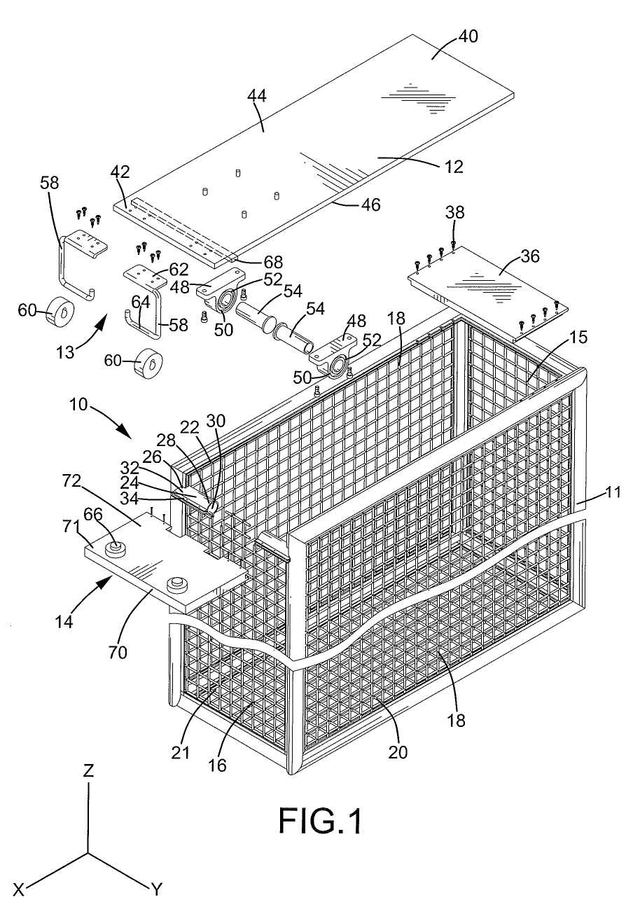

FIG. 2 shows a perspective view of the trap of FIG. 1.

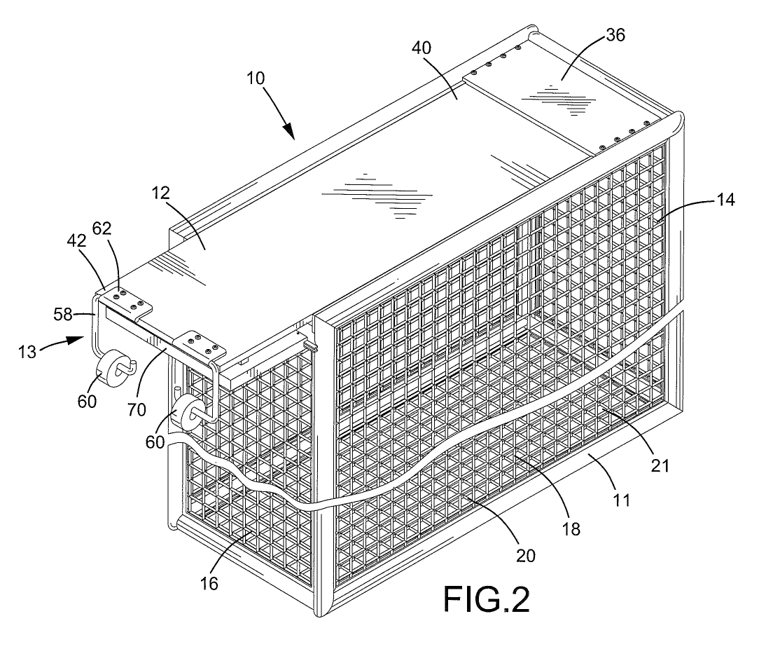

FIG. 3 shows a side view of the trap of FIG. 2.

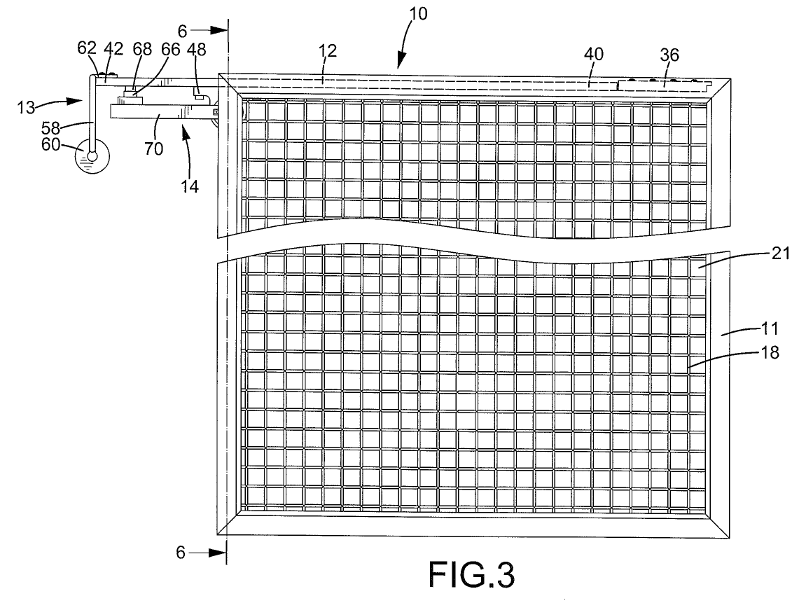

FIG. 4 shows a front view of the trap of FIG. 2.

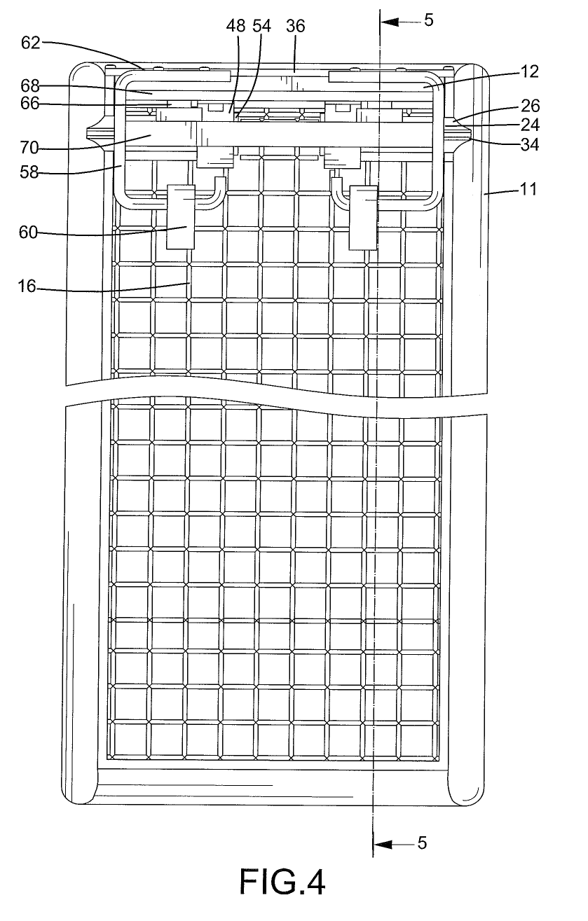

FIG. 5 shows a partial, cross sectional view of the trap of FIG. 2 according to section line 5-5 of FIG. 4.

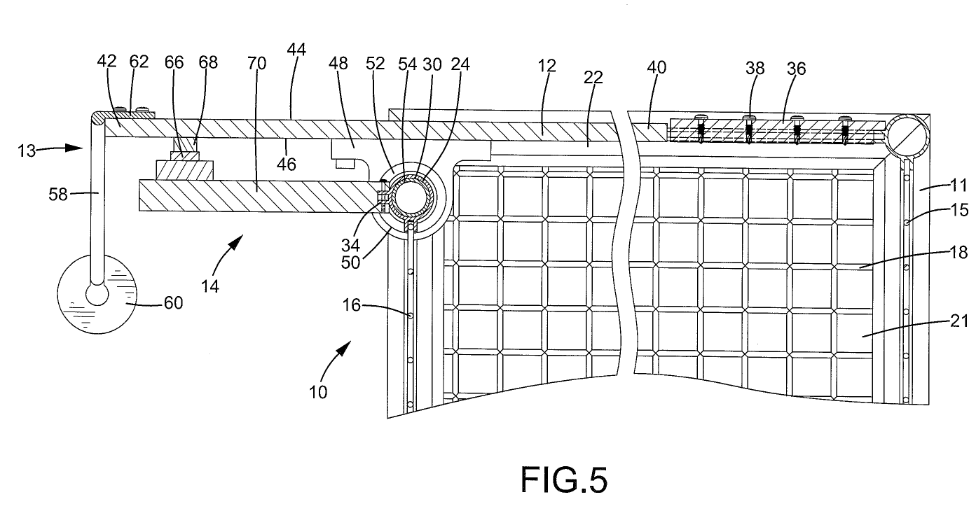

FIG. 6 shows a partial, cross sectional view of the trap of FIG. 2 according to section line 6-6 of FIG. 3.

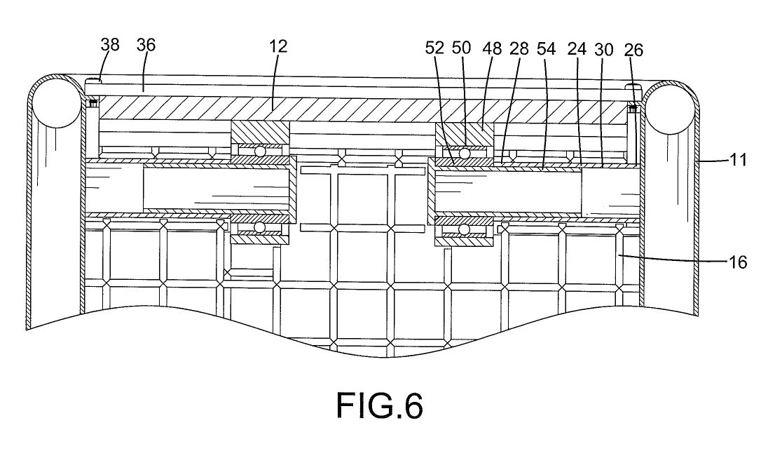

FIG. 7 shows a side view of the trap of FIG. 2 illustrating operation of the trap.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “lower”, “upper”, “outer”, “side”, “end”, “portion”, “longitudinal”, “radial”, “horizontal”, “inward”, “spacing”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A trap according to the preferred teachings of the present invention is shown in the drawings and generally designated 10. According to the preferred form shown, trap 10 includes a cage 11 having front and rear plates 15 and 16 spaced along a first axis X. Cage 11 further includes first and second side plates 18 extending between front and rear plates 15 and 16 and spaced along a second axis Y perpendicular to first axis X. Cage 11 further includes a bottom plate 20 extending between lower ends of front and rear plates 15 and 16 and lower ends of first and second side plates 18. In the most preferred form shown, each of front and rear plates 15 and 16, first and second side plates 18, and bottom plates 20 includes a plurality of meshes. Furthermore, front and rear plates 15 and 16, first and second side plates 18, and bottom plates 20 together define a capture space 21 having an opening 22 defined between upper ends of front and rear plates 15 and 16 and upper ends of first and second side plates 18 and spaced from bottom plate 20 along a third axis Z perpendicular to first and second axes X and Y. Furthermore, the upper end of rear plate 16 includes first and second pivotal seats 24 spaced along second axis Y. Each of first and second pivotal seats 24 is a tube in the most preferred form shown and includes a first end 26 fixed relative to the upper end of one of first and second side plates 18 and a second end 28 spaced from first end 26 along second axis Y. Second ends 28 of first and second pivotal seats 24 are spaced along second axis Y Each of first and second pivotal seats 24 has a longitudinal hole 30 extending from second end 28 through first end 26 along second axis Y Each of first and second pivotal seats 24 further includes a coupling portion 34 formed on an outer periphery 32 thereof and extending along second axis Y A bait board 36 is mounted in opening 22 and contiguous to the upper end of front plate 15. In the most preferred form shown, bait board 36 is fixed by screws 38 to the upper ends of first and second side plates 18.

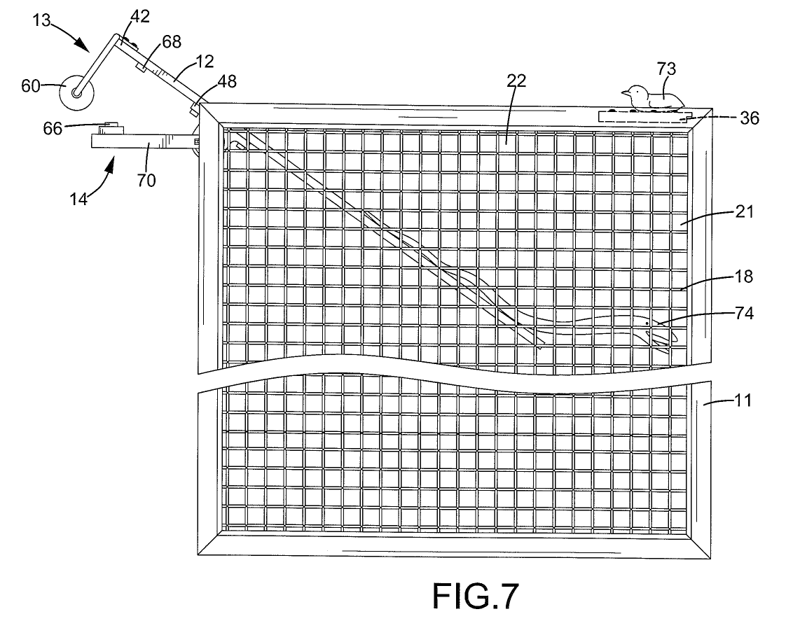

According to the preferred form shown, a cover 12 is pivotably mounted to cage 11 between a closing position closing opening 22 and a revealing position revealing opening 22. Cover 12 includes first and second ends 40 and 42 spaced along first axis X and top and bottom faces 44 and 46 spaced along third axis Z and extending between first and second ends 40 and 42. Two axle seats 48 are mounted to bottom face 46 of cover 12 and spaced along second axis Y Each axle seat 48 includes a hole 50 receiving a bearing 52 through which an axle 54 extends. Each axle 54 extends into longitudinal hole 30 of one of first and second pivotal seats 24. Thus, cover 12 can pivot relative to axles 54 and cage 11 about a pivot axis defined by axles 54 and parallel to second axis Y In the most preferred form shown, a spacing between first end 40 of cover 12 and the pivot axis along first axis X is larger than a spacing between second end 42 of cover 12 and the pivot axis along first axis X. When cover 12 is in the closing position substantially parallel to bottom plate 18, first end 40 of cover 12 is contiguous to bait board 36 and closes opening 22. On the other hand, when cover 12 is in the revealing position inside cage 11, opening 22 is revealed (FIG. 7).

According to the preferred form shown, a counterweight device 13 is mounted to second end 42 of cover 12 to bias cover 12 to the closing position. Namely, opening 22 is normally closed by cover 12 under action of counterweight device 13. In the most preferred form shown, counterweight device 13 includes two brackets 58 each having an upper end 62 in the form of a plate fixed to top face 44 of second end 42 of cover 12 and a lower end 64 having a hook. Counterweight device 13 further includes two counterweights 60 mounted to lower ends 64 of brackets 58. Thus, the torque imparted to second end 42 of cover 12 is not smaller than the torque imparted to first end 40 of cover 12.

According to the preferred form shown, a support device 14 includes a first magnetic member 66 mounted on cage 11 and a second magnetic member 68 mounted on cover 12. In the most preferred form shown, support device 14 includes a board 70 having a side 72 fixed by screws to coupling portions 34 of first and second pivotal seats 24. First magnetic member 66 includes two magnets fixed on a top face 71 of board 70. Second magnetic member 68 includes a metal strip fixed to bottom face 46 at second end 42 of cover 12 and extending along second axis Y. When cover 12 is in the closing position closing opening 22, first magnetic member 66 and second magnetic member 68 attract and engage with each other to securely retain cover 12 in the closing position.

In use, trap 10 according to the preferred teachings of the present invention is placed in a home range of animals, such as snakes, to be caught. A bait 73 is placed on bait board 36. In a case that an animal 74 (such as a snake) lured by bait 73 crawls onto cover 12 and moves from second end 42 towards first end 40 of cover 12, cover 12 remains in the closed position if the torque imparted to cover 12 by the weight of animal 74 is not greater than the magnetic attraction between first and second magnetic members 66 and 68. However, when animal 74 moves near first end 40 of cover 12, the arm of force from animal 74 to the pivot axis of cover 12 is increased, such that the torque imparted to cover 12 by the weight of animal 74 increases to an extent greater than the magnetic attraction between first and second magnetic members 66 and 68. Thus, first end 40 of cover 12 pivots inward into cage 11, and animal 74 falls into cage 11. After animal 74 has fallen into cage 11, the torque imparted by animal 74 to cover 12 disappears. As a result, cover 12 returns to its closing position under the action of counterweight device 13, and animal 74 is trapped in cage 11.

Now that the basic teachings of the present invention have been explained, many extensions and variations will be obvious to one having ordinary skill in the art. For example, first and second magnetic members 66 and 68 can exchange. Specifically, second magnetic member 68 can includes two magnets fixed on top face 71 of board 70, whereas first magnetic member 66 can include a metal strip fixed to bottom face 46 at second end 42 of cover 12.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A trap comprising, in combination:
a cage defining a capture space having an opening in an upper end of the cage;
a cover pivotable about a pivot axis between a closing position closing the opening and a revealing position revealing the opening, with the cover including a first end and a second end having a spacing to the pivot axis smaller than the first end of the cover; and
a counterweight device mounted to the second end of the cover to bias the cover to the closing position, with the cover moving to the revealing position when an animal moves to the first end of the cover, such that the animal falls into the capture space.

2. The trap as claimed in claim 1, with the cage including front and rear plates spaced along a firs taxis, with the cage further including first and second side plates extending between the front and rear plates extending between the front and rear plates and spaced along a second axis perpendicular to the first axis, with the cage further including a bottom edge extending between lower ends of the front and rear plates and lower ends of the first and second side plates, with the opening defined between upper ends of the front and rear plates and upper ends of the first and second side plates, with the bottom edge spaced from the opening along a third axis perpendicular to the first and second axes, with the capture space defined by the front and rear plates, the first and second side plates, and the bottom plate, and with the first and second ends of the cover spaced along the first axis.

3. The trap as claimed in claim 2, further comprising, in combination:
a first magnetic member mounted on one of the cage and the cover; and
a second magnetic member mounted on the other of the cage and the cover, with the first and second magnetic members attracting and engaging with each other when the cover is in the closing position, maintaining the cage in the closing position.

4. The trap as claimed in claim 3, further comprising, in combination:
first and second pivotal seats each having a first end fixed relative to one of the upper end of the first and second side plates, with each of the first and second pivotal seats further including a second end, with the second ends of the first and second pivotal seats spaced along the second axis, with each of the first and second pivotal seats further including a longitudinal hole extending from the second end thereof through the first end thereof, and
first and second axle seats, with the cover including top and bottom faces spaced along the third axis, with the first and second axle seats mounted to the bottom face of the cover and spaced along the second axis, with each of the first and second axle seats having a hole receiving an axle, with the axle in the first axle seat rotatably received in the longitudinal hole of the first pivotal seat, with the axle in the second axle seat rotatably received in the longitudinal hole of the second pivotal seat, allowing the cover to pivot about the pivot axis defined by the axles.

5. The trap as claimed in claim 4, further comprising, in combination: a board fixed to an outer periphery of each of the first and second pivotal seats, with the first magnetic member including a magnet fixed on a top face of the board, with the second magnetic member including a metal strip fixed to the bottom face at the second end of the cover.

6. The trap as claimed in claim 3, with the counterweight device including first and second brackets each having an upper end fixed to the second end of the cover and a lower end, with the counterweight device further including first and second counterweights mounted to the lower ends of the first and second brackets, and with the counterweights imparting a torque to the cover to bias the cover to the closing position.

7. The trap as claimed in claim 6, further comprising, in combination: a bait board mounted in the opening and contiguous to the upper end of the front plate, with a bait adapted to be placed on the bait board, with the first end of the cover in the closing position being contiguous to the bait board and closing the opening.
